(19) United States
(12) Patent Application Publication
(10) Pub. No.: US 2014/0033651 A1
(43) Pub. Date: Feb. 6, 2014

(54) Gifting System and Method

(71) Applicant: Katherine A. Cunningham, Bethel, CT (US)

(72) Inventor: Katherine A. Cunningham, Bethel, CT (US)

(21) Appl. No.: 13/564,533

(22) Filed: Aug. 1, 2012

(51) Int. Cl. B65D 30/22; B42D 115/00; B65B 5/06

(52) U.S. Cl. 53/411; 206/232

(57) ABSTRACT

A gifting system comprising: a gift bag; a pocket on the outer surface of the gift bag, the pocket with an opening on its top side; a card shell with a front face, an upper side, a bottom side, and a folding side; an insert, with a folding side, configured to nest inside the card shell; an attachment means configured to removeably attach the insert to the card shell; wherein the card shell with the insert attached inside of the card shell, is configured to slide into and out of the pocket. A method of using a gifting system, the method comprising: placing a gift into a gift bag; writing a note on an insert; sliding the card shell and insert into a pocket of the gift bag; and giving the gift and gift bag to a recipient.

### TECHNICAL FIELD

The present invention generally relates to a gifting system and method, and more specifically to a gifting system that is generally reusable and a method of using the gifting system.

### BACKGROUND

People often give presents which are contained in a gift bag to enhance the presentation of the gift. Gift bags can take a number of forms, but are typically made of paper or plastic, with color or patterns or designs that are appropriate to the occasion. A gift card is often loosely enclosed in the bag. Usually, after use, the card and gift bag are simply thrown away, possibly to be taken to a landfill. In this day and age, with limited natural resources, throwing away gift bags and gift cards seems wasteful.

Thus there is a need for a gifting system and method that will overcome the above listed and other disadvantages.

### SUMMARY

The disclosed invention relates to a gifting system comprising: a gift bag; a pocket on the outer surface of the gift bag, the pocket with an opening on its top side; a card shell with a front face, an upper side, a bottom side, and a folding side; an insert, with a folding side, configured to nest inside the card shell; an attachment means configured to removeably attach the insert to the card shell; wherein the card shell with the insert attached inside of the card shell, is configured to slide into and out of the pocket.

The disclosed invention also relates to a method of using a gifting system, the method comprising: placing a gift into a gift bag; writing a note on an insert; sliding the card shell with attached insert into a pocket of the gift bag; and giving the gift and gift bag to a recipient.

In addition, the disclosed invention relates to a method of using a gifting system, the method comprising: removing a gift from a gift bag; removing an insert from a card shell; placing new gift in the gift bag; obtaining a new insert; writing a note on the new insert; attaching the new insert to the card shell using the attaching means; sliding the card shell and new insert into a pocket of the gift bag; and giving the new gift and gift bag to a new recipient.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of the gift bag;

FIG. 2 is a perspective view of the card shell;

FIG. 3 is a perspective view of the insert;

FIG. 4 is a perspective view of the gift bag with the card shell with attached insert and extra insert inside the pocket;

FIG. 5 is a detail view of the card shell;

FIG. 6 is a detail view of the insert;

FIG. 7 is a detail view of a ribbon;

FIG. 8 is detail view of the card shell and insert;

FIG. 9 perspective view of another embodiment of the card shell;

FIG. 10 is a flowchart illustrating a method; and

FIG. 11 is another flow chart illustrating a method.

### DETAILED DESCRIPTION

FIG. 1 shows one embodiment of a disclosed gift bag 10. The gift bag 10 may have handles 14. The gift bag 10 will have a pocket 18. The pocket 18 may have four sides 22, 26, 30, 34. Three of the four sides 22, 26, 30 will be closed with respect to or sealed to the surface of the gift bag 10. The pocket 18 will have an opening 39 located at its top side 34. In one embodiment, the pocket may be about 8.9 inches in height and about 7.2 inches wide.

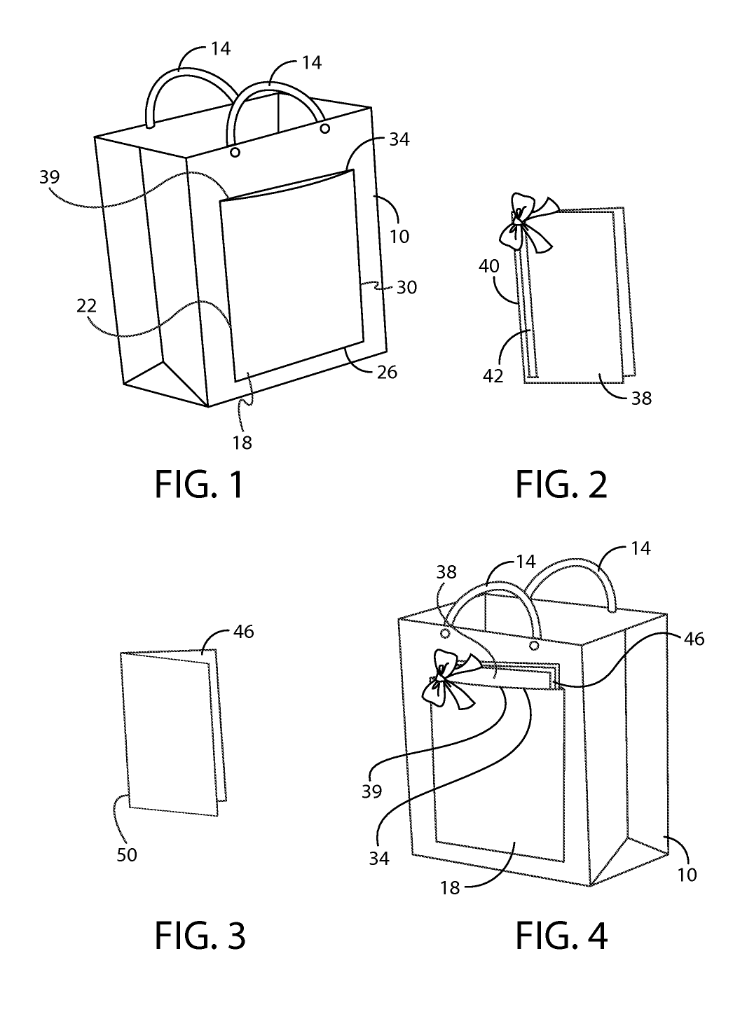

FIG. 2 shows a card shell 38 with an attachment means 42. In one embodiment the attachment means 42 may be a ribbon, string, line, or wire. The card shell 38 may be made of card stock, and may be folded along one side 40, this may be referred to as the folding side 40 of the card shell 38.

FIG. 3 shows an insert 46. The insert 46 may be made out of paper, bond, or card stock. The insert 46 may be folded along one side 50. The insert 46 will generally be slightly smaller than the card shell 38. The insert 46 is removably attachable to the interior of the card shell 38 via the attachment means 42. In other words, the insert 46 is nested inside the card shell 38 and held in place by the attachment means 42.

FIG. 4 shows the gift bag 10. The insert 46 is shown inside the card shell 38. Both the card shell 38 with attached insert 46 are inside the pocket 18. The card shell 38 and insert 46 can be slid in and out of the pocket 18. In other embodiments there may be one or more extra blank inserts 46 inside the pocket 18.

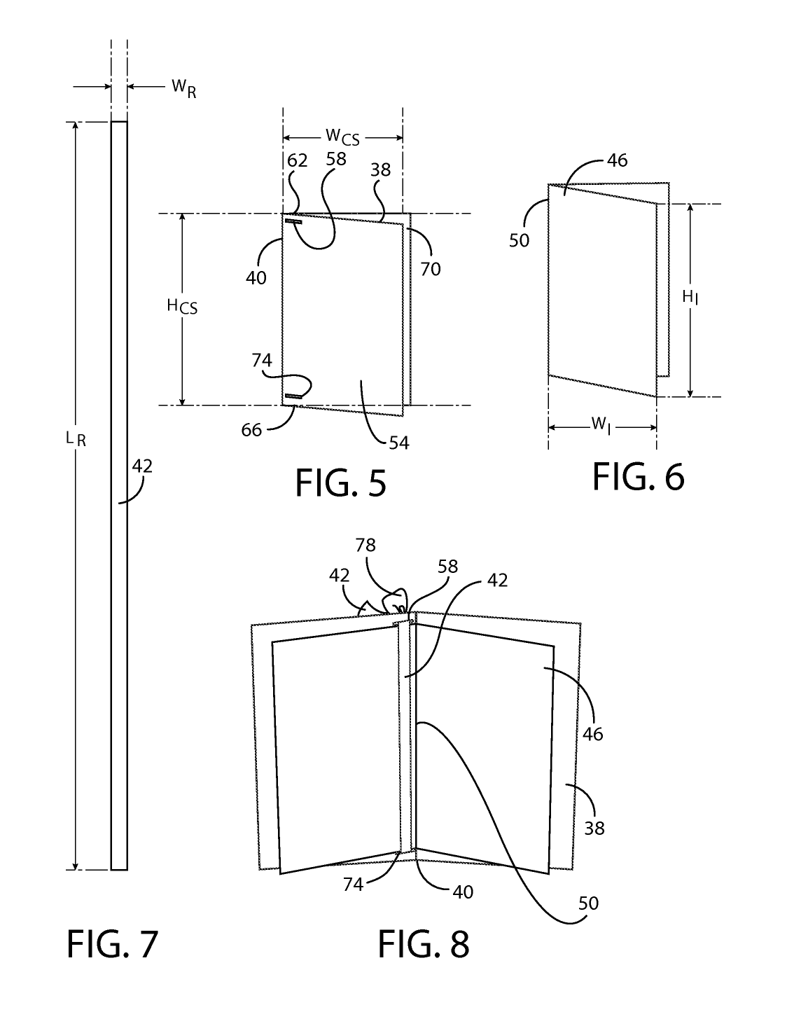

FIG. 5 is close up view of the card shell 38 without the ribbon 42. The card shell 38 is folded to create side 40. The card shell 38 has a front face 54. On the front face 54 near the side 40 is a first slot 58, near the top side 62 of the card shell 38. Similarly, on the front face 54 near the side 40 is a second slot 74, near the bottom side 66 of the card shell 38. The slots 58, 74 goes through the front face 54 of the card shell 38, but not through the rear face 70. The card shell 38 has a height H_{CS} and a width W_{CS}. In one embodiment the H_{CS} may be about 9 and ⅛ inches, and W_{CS} may be about 5.8 inches. The slots 58, 74 may be about 0.5 inches long. The first slot 58 may be about 0.3 inches from the top side 62, and the second slot 74 may be about 8.8 inches from the top side.

FIG. 6 is a close up view of the insert 46. The insert 46 is folded to create side 50. The insert 46 has a height H₁ and a width W₁. In one embodiment the H₁ may be about 8.5 inches, and W₁ may be about 5.5 inches.

FIG. 7 shows one embodiment of the ribbon 42. The ribbon will have a length L_{R} and a width W_{R}. In one embodiment, the L_{R} may be about 28 inches, and the W_{R} may be about 0.38 inches.

FIG. 8 shows the card shell 38 with the insert 46 attached to its interior via the ribbon 42. The ribbon 42 is threaded through the slots 58, 74 as shown and may be tied into a decorative knot or bow 78. The ribbon 42 holds the insert generally at the fold side 50 against the card shell 38 and adjacent to the fold side 40 of the card shell 38. The slots 58, 74 allow for a tighter fit between the ribbon and the insert 46 without tending to bend, or crumple the card shell 38.

In another embodiment, the gifting system may come with the insert 46 already attached to the card shell 38. Thus, when one writes a note on the insert 46, the insert 46 is already attached to the card shell 38. In another embodiment of the invention, the gifting system may come with one or more extra inserts 46 for use with the card shell 38. The extra inserts 46 may be stored in the pocket 18.

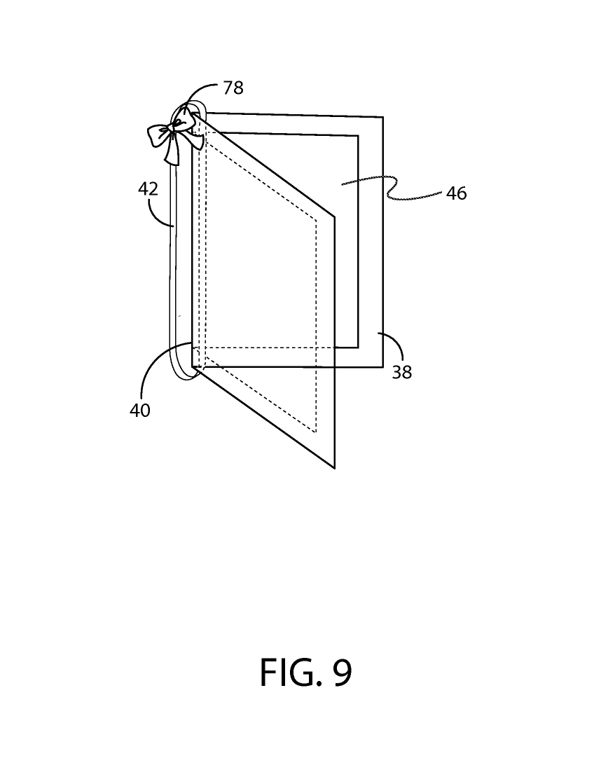

FIG. 9 is another embodiment of the card shell 38. In this embodiment, the card shell 38 does not have slots. The ribbon is looped around the entire card shell 38 generally about the fold 40 of the card shell 38. The ribbon 42, once tied into a knot or bow 78, will hold the insert 46 against the card shell 38 via the insert fold 50 (not seen in this view).

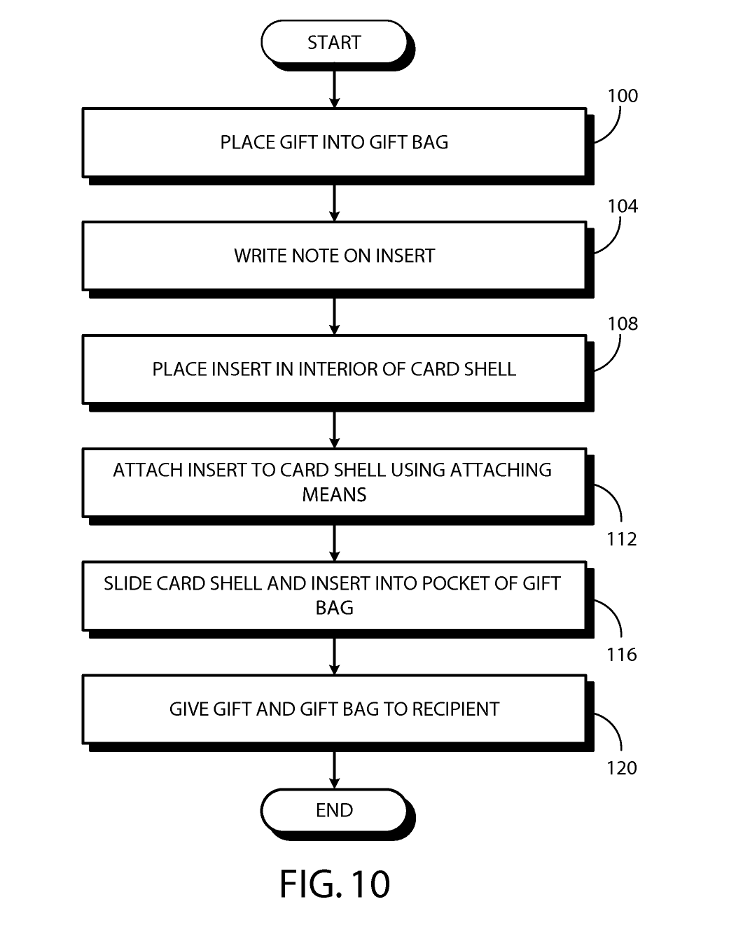

FIG. 10 illustrates a method of using the gifting system. At act 100 one places a gift into the gift bag 10. At act 104 one writes a note on the insert 46. In one embodiment, the insert 46 may be pre-attached to the card shell 38, hence acts 108 and 112 may be skipped in that embodiment. However, in another embodiment, or if the insert 46 has been removed from the card shell 38, then at act 108 one places the insert 46 in the interior of the card shell 38. At act 112 one attaches the insert 46 to the car shell 38 using the attaching means 42. At act 116 one slides the card shell 38 with attached insert 46 into the pocket 18 of the gift bag 10. In one embodiment, there may be one or more additional blank inserts in the pocket 18, so at act 116 one may slide the card shell 38 with attached insert 46 “in front” of the additional insert 46, so that the inserts are generally between the card shell and the gift bag 10. At act 120 one gives the gift and gift bag to a recipient.

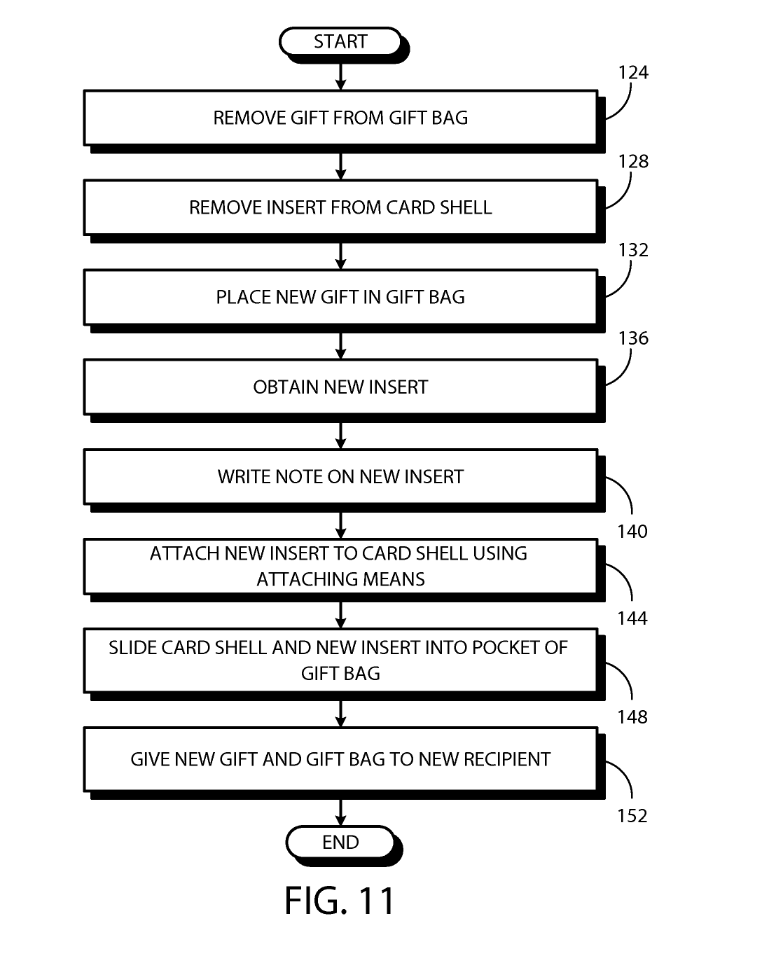

FIG. 11 illustrates another method of using the gifting system. After one has received the gift and gift bag 10, one removes the gift from the gift bag 10 at act 124. At act 128 one removes the insert 46 from the card shell 38. At act 132 one places a new gift in the gift bag 10. At act 136 one obtains a new insert 46. In one embodiment, one or more new inserts 46 may come with the gifting system, and may already be stored in the pocket 18. In another embodiment, one may simply use a piece of paper as an insert 46. At act 140 one writes a note on the new insert 46. At act 144 one attaches the new insert 46 to the card shell 38 using the attaching means 42. At act 148, one slides the card shell 38 and new insert 46 into the pocket 18 of the gift bag 10. At act 152 once gives the new gift and gift bag to a new recipient.

In use, one simply puts a present in the gift bag 10. Then one writes a note on the insert, and then attaches the insert 46 to the card shell 38 via the ribbon 42. Then the card shell 38, insert 46, and ribbon 42 are placed in the pocket 18. When the receiver of the gift has received the gift and read the note, the receiver can re-use the gifting system, by simply saving the insert 46, disposing of or recycling the insert 46. The receiver obtains a new insert (in one embodiment the insert 46 is simply a sheet of 8.5 inches by 11 inches paper folded in half so that the insert 46 has a height of 8.5 and a width of 5.5 inches), writes a note for the new gift receiver. The receiver then attaches the insert 46 to the card shell 38 via the ribbon 42. The gifting system can be re-used many times, thus saving resources and reducing the production of garbage.

The disclosed invention has many advantages. The gift bag, card shell and attachment means can be re-used many times. In order to write a new note, one can simply use a piece of regular 8.5 inch by 11 inch paper folded in half. This is a “green product” due to its re-usability.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A gifting system comprising:
a gift bag;
a pocket on the outer surface of the gift bag, the pocket with an opening on its top side;
a card shell with a front face, an upper side, a bottom side, and a folding side;
an insert, with a folding side, configured to nest inside the card shell;
an attachment means configured to removeably attach the insert to the card shell;
wherein the card shell with the insert attached inside of the card shell, is configured to slide into and out of the pocket.

2. The gifting system of claim 1, further comprising:
a first slot located near the top side of the card shell and near the folding side of the card shell;
a second slot located near the bottom side of the card shell and near the folding side of the card shell;
and wherein the attachment means is a ribbon configured to slide into the first and second slots.

3. The gifting system of claim 1, wherein the card shell has a height of about 9 and ⅛ inches, and a width of about 5.8 inches, and the insert has a height of about 8 and ½ inches and a width of about 5 and a half inches.

4. The gifting system of claim 1, wherein the card shell is made from card stock and the insert is made from a sheet of paper.

5. The gifting system of claim 1, wherein the attachment means is a ribbon configured to loop around the card shell and the insert generally near the folded side of the card shell and the fold side of the of the insert, and be tighten such that the insert is generally held against the inside of the card shell.

6. The gifting system of claim 1, wherein the insert is pre-attached to the card shell via the attachment means.

7. The gifting system of claim 1, further comprising:
one or more additional inserts, each with a folding side, and each configured to nest inside the card shell.

8. The gifting system of claim 1, wherein the additional inserts are stored in the pocket.

9. A method of using a gifting system, the method comprising:
placing a gift into a gift bag;
writing a note on an insert;
sliding a card shell attached to the insert into a pocket of the gift bag; and
giving the gift and gift bag to a recipient.

10. The method of using a gifting system of claim 9, wherein the insert is pre-attached to the card shell.

11. The method of using of a gifting system of claim 9, the method further comprising
placing the insert in an interior of a card shell;
attaching the insert to the card shell using an attaching means.

12. A method of using a gifting system, the method comprising:
removing a gift from a gift bag;
removing an insert from a card shell;
placing new gift in the gift bag;
obtaining a new insert;
writing a note on the new insert;
attaching the new insert to the card shell using the attaching means;
sliding the card shell with new insert attached into a pocket of the gift bag; and
giving the new gift and gift bag to a new recipient.

13. The method of using a gifting system of claim 12, wherein the act of obtaining a new insert further comprises:
obtaining a new insert from the pocket of the gift bag.

14. The method of using a gifting system of claim 12, wherein the act of obtaining a new insert further comprises:
obtaining a new insert by obtaining a sheet of paper and folding in half
